(19) United States
(12) Patent Application Publication
(10) Pub. No.: US 2021/0115709 A1
(43) Pub. Date: Apr. 22, 2021

(54) INSIDE HANDLE DEVICE

(71) Applicant: ALPHA CORPORATION, Kanagawa (JP)

(72) Inventors: Ryoichi TANAKA, Yokohama-shi (JP); Yoshiyuki NAGATANI, Yokohama-shi (JP)

(73) Assignee: ALPHA CORPORATION, Kanagawa (JP)

(21) Appl. No.: 17/136,519

(22) Filed: Dec. 29, 2020

Related U.S. Application Data
(63) Continuation of application No. PCT/JP2019/029915, filed on Jul. 30, 2019.

(30) Foreign Application Priority Data
Jul. 30, 2018 (JP) 2018-142273

(51) Int. Cl. E05B 85/12; E05B 85/16

(52) U.S. Cl. CPC E05B 85/12; E05B 85/16

(57) ABSTRACT

An inside handle device includes a handle base attached to a door panel of a vehicle and an operation handle member rotatably supported on the handle base. The operation handle member includes a handle shaft support portion that is provided on a base end side of the operation handle member and serves as a rotation fulcrum point of the operation handle member a grip portion that is provided on a leading end side of the operation handle member and is configured to be gripped and operated by an occupant when the occupant opens a door of the vehicle, and a parting line formed on a door panel side with respect to the grip portion.

### CROSS-REFERENCE TO RELATED APPLICATIONS

This is a continuation of International Application No. PCT/JP2019/029915 filed on Jul. 30, 2019, and claims priority from Japanese Patent Application No. 2018-142273 filed on Jul. 30, 2018, the entire content of which is incorporated herein by reference.

### TECHNICAL FIELD

The present invention relates to an inside handle device.

### BACKGROUND ART

An inside handle device (a vehicle inside handle device) is mounted on a door of a vehicle which is an automobile or the like.

The inside handle device includes, for example, a handle base attached to a door panel of the vehicle and an operation handle member rotatably supported on the handle base. A surface of the operation handle member may be plated, for example, by performing chrome plating.

The operation handle member is generally formed by injection molding a synthetic resin material. The operation handle member after molding has a step due to a parting line (a dividing line of a mold). In order to remove the parting line from the operation handle member after molding, it is necessary to perform a polishing process. However, based on a viewpoint of reducing manufacturing cost of the inside handle device, it is preferable to reduce the polishing process of the operation handle member as much as possible.

### CITATION LIST

### Patent Literature

Patent Literature 1: JP-A-2009-299264

### SUMMARY OF INVENTION

According to an embodiment, an inside handle device includes a handle base attached to a door panel of a vehicle and an operation handle member rotatably supported on the handle base. The operation handle member includes a handle shaft support portion that is provided on a base end side of the operation handle member and serves as a rotation fulcrum point, and a grip portion that is formed on a leading end side of the operation handle member and is configured to be gripped and operated by an occupant when the occupant opens a door of the vehicle. A parting line generated when the operation handle member is molded is formed at a portion of the operation handle member provided on a door panel side with respect to the grip portion.

According to the inside handle device in the embodiment, manufacturing cost can be reduced by reducing a polishing process of the operation handle member.

### BRIEF DESCRIPTION OF DRAWINGS

FIG. 1 is a perspective view of an inside handle device according to an embodiment.

FIG. 2 is an exploded perspective view of the inside handle device according to the embodiment.

FIG. 3 is a front view of the inside handle device according to the embodiment.

FIG. 4 is a cross-sectional view taken along a line A-A in FIG. 3.

FIG. 5 is a front view of an operation handle member.

FIG. 6 is a cross-sectional view taken along a line B-B in FIG. 5.

FIG. 7 is a cross-sectional view that shows a mold releasing direction of a mold and corresponds to a cross section taken along the line B-B in FIG. 5.

FIG. 8 is a cross-sectional view that shows the mold releasing direction of the mold and corresponds to a cross section taken along a line C-C in FIG. 5.

FIG. 9 is a perspective view of the operation handle member and shows a parting line.

FIG. 10 is a front view of the operation handle member and shows the parting line.

### DESCRIPTION OF EMBODIMENTS

Hereinafter, an embodiment will be described in detail with reference to the drawings.

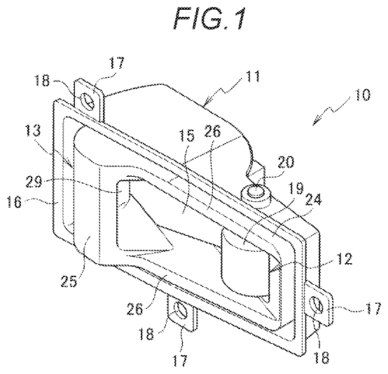

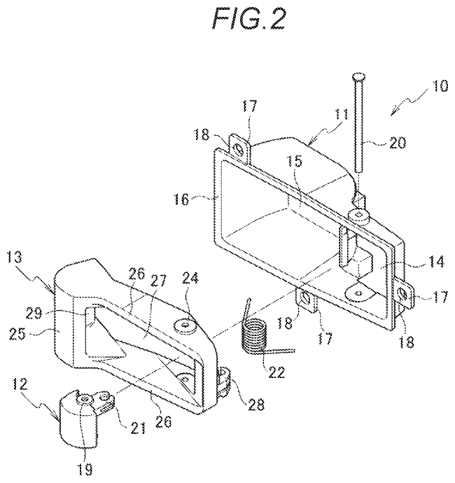

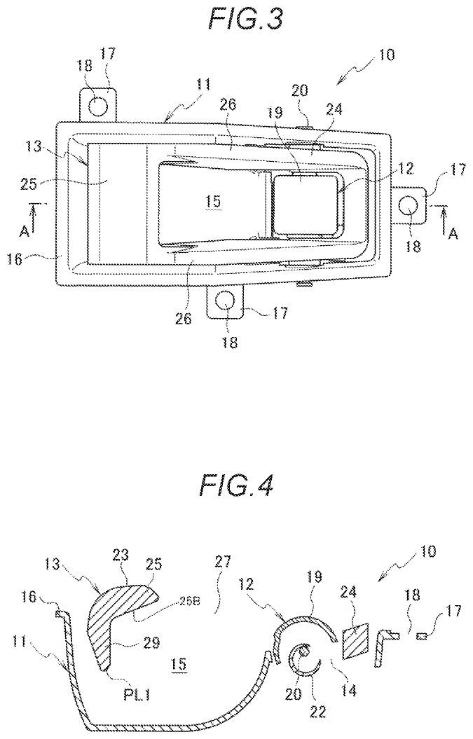

As shown in FIGS. 1 to 4, an inside handle device 10 includes a handle base 11, a lock lever 12, and an operation handle member 13. The inside handle device 10 is fixed to an inner panel (not shown) that constitutes a door panel of a vehicle, and is partially exposed from a door trim (not shown) facing a vehicle interior. A Bowden cable (not shown) provided inside the door panel is connected to the inside handle device 10. The Bowden cable (not shown) includes an outer tube having a tubular shape and an inner wire inserted into the outer tube.

The handle base 11 is formed by injection molding, for example, a synthetic resin material. The handle base 11 includes a shaft support hole 14 which is a through hole on one side, and an operation recess 15 that is adjacent to the shaft support hole 15 and has a concave shape. A pair of tube holding portions (not shown) are provided at one side end portion of the shaft support hole 14. The tube holding portions (not shown) each hold a respective one of end portions of outer tubes of the Bowden cable on a lock lever 12 side and the Bowden cable on an operation handle member 13 side.

A plurality of locking pieces 17 are provided on a frame portion 16 of the handle base 11. Each of the locking pieces 17 is formed with a fixing portion 18 which is a through hole. The inside handle device 10 is fixed to an inner panel by inserting a fixing screw (not shown) into the fixing portion 18 and screwing the fixing screw to the inner panel.

The lock lever 12 is rotatably supported on the handle base 11. The lock lever 12 is formed by injection molding, for example, a synthetic resin material. The lock lever 12 is also referred to as a lock knob. The lock lever 12 is adjacent to the operation handle member 13, and is provided on the handle base 11.

A lock shaft support portion 19 which is a rotation fulcrum point of the lock lever 12 is provided on a base end side of the lock lever 12. The lock shaft support portion 19 is rotatably supported in the shaft support hole 14 of the handle base 11 via, a support shaft 20. The lock shaft support portion 19 of the lock lever 12 is provided with a lock side wire holding portion 21. An end portion of an inner wire of the Bowden cable on the lock lever 12 side is connected to the lock side wire holding portion 21.

The operation handle member 13 is rotatably supported on the handle base 11. The operation handle member 13 is biased toward an initial position by a coil spring 22 mounted on the support shaft 20, and rattling or the like at the initial position is prevented.

The operation handle member 13 is formed by injection molding, for example, a synthetic resin material. In the present embodiment, the operation handle member 13 is formed in a so-called ring shape. The operation handle member 13 is plated, for example, by performing chrome plating. Therefore, a plating layer 23 is formed by performing plating on a surface of the operation handle member 13.

A handle shaft support portion 24 is provided on a base end side of the operation handle member 13. The handle shaft support portion 24 is rotatably supported in the shaft support hole 14 of the handle base 11 via the support shaft 20. A grip portion 25 is formed on a leading end side of the operation handle member 13. When opening a door of a vehicle, an occupant grips and operates the grip portion 25. When the operation handle member 13 is biased by the coil spring 22 and is located at the initial position, the grip portion 25 is held in the operation recess 15. By connecting the handle shaft support portion 24 and the grip portion 25 by a pair of connection portions 26, 26, the operation handle member 13 is formed in a ring shape in which an opening 27 is formed in a central part of the operation handle member 13.

The handle shaft support portion 24 of the operation handle member 13 is provided with a handle side wire holding portion 28. An end portion of an inner wire of the Bowden cable on the operation handle member 13 side is connected to the handle side wire holding portion 28.

A grip portion back surface 25B is provided on a door panel side of the grip portion 25. When opening the door of the vehicle, the occupant hooks a finger on the grip portion back surface 25B and pulls the operation handle member 13 toward the vehicle interior. The grip portion back surface 25B expands in a substantially plan shape.

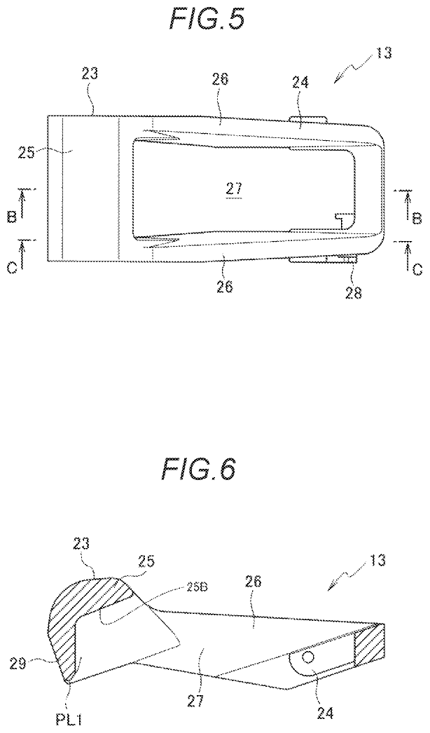

According to the embodiment, as shown in FIGS. 5 and 6, the operation handle member 13 includes a wall portion 29 that defines the grip portion 25. The wall portion 29 extends from the leading end side of the operation handle member 13 in the grip portion 25 to the door panel side (an outside in a vehicle width direction). In order to prevent the finger of the occupant from touching a parting line PL1, the parting line PL1 is formed at an end part of the wall portion 29. That is, in the present embodiment, the parting line PL1 is formed on the wall portion 29, which is a portion of the operation handle member 13 that the occupant does not touch with the finger, so that it is not necessary to polish the parting line PL1.

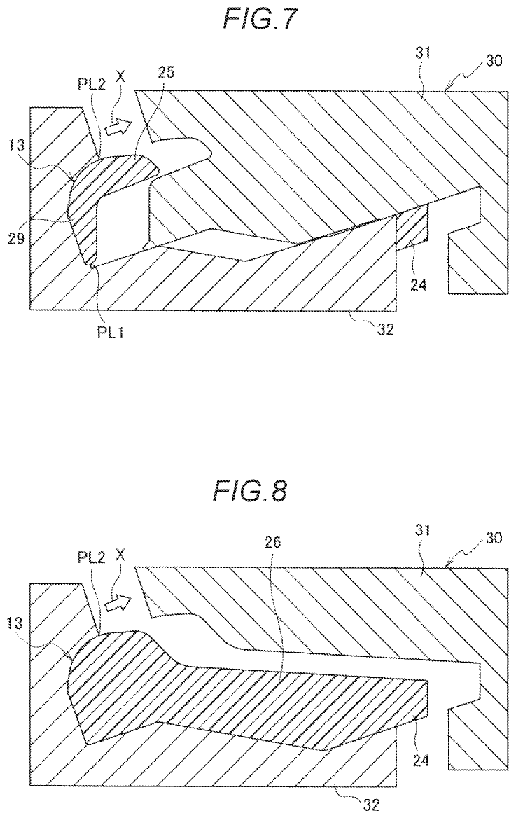

The operation handle member 13 is formed by injection molding a synthetic resin material. According to an embodiment, the operating handle member 13 is molded using the mold (injection mold) 30 shown in FIGS. 7 and 8. The mold 30 shown in FIGS. 7 and 8 includes an upper mold 31 and a lower mold 32 that face each other in an upper-lower direction and are relatively movable in an oblique direction (see an arrow X in FIGS. 7 and 8).

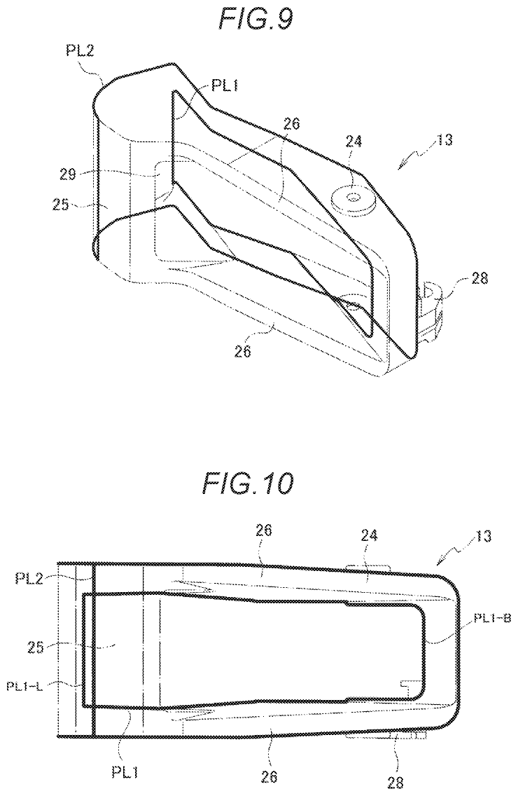

As shown in FIGS. 9 and 10, parting lines PL1, PL2, which are minute linear protrusions generated on a mating surface of the molds when the operation handle member 13 is molded by performing injection molding, are formed on the surface of the operation handle member 13.

The first parting line PL1 is annularly formed. The first patting line PL1 is formed on an inner peripheral side of a ring-shaped operating handle over an entire circumference. The second parting line PL2 is annularly formed. The second parting line PL2 is formed on an outer peripheral side of the ring-shaped operating handle over the entire circumference.

The first parting line PL1 annularly formed includes a base end side part PL1-B extending parallel to a rotation axis of the operation handle on the base end side of the operation handle member 13, and a leading end side part PL1-L extending parallel to the rotation axis of the operation handle on the leading end side of the operation handle member 13. When the inside handle device 10 is attached to the door panel of the vehicle, the first parting line PL1 is located on the door panel side (the outside in the vehicle width direction) with respect to a surface on which the grip portion back surface 25B of the grip portion 25 expands over the entire circumference. The leading end side part PL1-L of the first parting line PL1 is located on the door panel side with respect to the grip portion back surface 25B.

The first parting line PL1 is formed on an inner peripheral side of the ring shape of the operation handle member 13. In a case in which the parting line PL1 is formed on the inner peripheral side of the ring shape of the operation handle member 13, it is generally difficult to perform polishing by an automatic polishing machine, and it is common to perform manual polishing which requires more time and effort as compared with the polishing performed by an automatic polishing machine. However, in the present embodiment, the first parting line PL1 is formed on the wall portion 29, which is a portion of the operation handle member 13 that the occupant does not touch with the finger, so that it is not necessary to polish the parting line PL1.

On the other hand, the second parting line PL2 is formed on an outer peripheral side of the ring shape of the operation handle member 13. When the parting line PL2 is formed on the outer peripheral side of the ring shape of the operation handle member 13, it is possible to sufficiently perform the polishing by an automatic polishing machine. Therefore, in the present embodiment, the second parting line PL2 is polished and removed.

According to the present embodiment, the inside handle device 10 includes the handle base 11 attached to the door panel of the vehicle and the operation handle member 13 rotatably supported on the handle base 11. The operation handle member 13 includes the handle shaft support portion 24 that is provided on the base end side of the operation handle member 13 and is a rotation fulcrum point, and the grip portion 25 that is formed on the leading end side of the operation handle member 13 and is configured to be gripped and operated by the occupant when the occupant opens the door of the vehicle. The parting line PL1 generated when the operation handle member 13 is molded is formed at a portion of the operation handle member 13 provided on the door panel side (the outside in the vehicle width direction) with respect to the grip portion 25.

In the inside handle device 10, the parting line PL1 is formed at the portion of the operation handle member 13 provided on the door panel side (the outside in the vehicle width direction) with respect to the grip portion 25, so that the finger of the occupant does not touch the parting line PL1. Therefore, it is not necessary to polish the parting line PL1.

Therefore, according to the inside handle device 10, manufacturing cost can be reduced by reducing a polishing process of the operation handle member 13.

The operation handle member 13 includes the wall portion 29 extending from the grip portion 25 toward the door panel side (the outside in the vehicle width direction), and the parting line PL1 is formed at the end part of the wall portion 29.

By forming the parting line PL1 in this manner, it is possible to form the parting line PL1 at a position of the operation handle member 13 that the occupant does not touch with the finger, and it is not necessary to polish the parting line PL1.

The surface of the operation handle member 13 is plated. Therefore, the plating layer 23 is formed by performing plating on the surface of the operation handle member 13.

By forming the parting line PL1 as described above, it is possible to form the parting line PL1 at the position of the operation handle member 13 that the occupant does not touch with the finger, and to prevent peeling of the plating layer 23 starting from a vicinity of the parting line PL1.

The inside handle device according to the present invention has been described by taking the above-described embodiment as an example. However, the present invention is not limited to the embodiment and can use various other embodiments without departing from the spirit of the present invention.

### REFERENCE SIGNS LIST

10 inside handle device
11 handle base
13 operation handle member
24 handle shaft support portion
25 grip portion
25B grip portion back surface
29 wall portion
PL1 parting line
PL1-B base end side part of parting line
PL1-L leading end side part of parting line

1. An inside handle device comprising:
a handle base attached to a door panel of a vehicle; and
an operating handle member rotatable supported on the handle base,
wherein the operation handle member includes:
a handle shaft support portion that is provided on a base end side of the operation handle member and serves as a rotation fulcrum point of the operation handle member;
a grip portion that is provided on a leading end side of the operation handle member and is configured to be gripped and operated by an occupant when the occupant opens a door of the vehicle; and
a parting line formed on a door panel side with respect to the grip portion.

2. The inside handle device according to claim 1, wherein the operation handle member includes a wall portion extending from the grip portion toward the door panel side, and
wherein the parting line is formed at an end part of the wall portion.

3. The inside handle device according to claim 1, wherein the operation handle member further includes a pair of connection portions,
wherein the handle shaft support portion and the grip portion are connected by the pair of connection portions, and the operation handle member is formed in a ring shape,
wherein the parting line is annularly formed, and
wherein the parting line is formed on an inner peripheral side of the ring shape of the operation handle member over an entire circumference.

4. The inside handle device according to claim 3, wherein the parting line annularly formed includes a base end side part formed on the base end side of the operation handle member and a leading end side part formed on the leading end side of the operation handle member, and a grip portion back surface on which an occupant hooks a finger when opening a door of a vehicle is provided on the door panel side of the grip portion, and
wherein the leading end side part of the parting line is located on the door panel side with respect to the grip portion back surface.

5. The inside handle device according to claim 3, wherein a grip portion hack surface on which an occupant hooks a finger when opening a door of a vehicle is provided on the door panel side of the grip portion, and
wherein the parting line is located on the door panel side with respect to the grip portion back surface over an entire circumference.

6. The inside handle device according to claim 1, wherein a surface of the operation handle member is plated.

7. A method of manufacturing an operation handle member configured to be rotatably supported on a handle base attached to a door panel of a vehicle, wherein the operation handle member includes a handle shaft support portion provided on a base end side of the operation handle member, and a grip portion provided on a leading end side of the operation handle member, the method of manufacturing an operation handle member comprising:
preparing a mold so that a parting line is formed on a door panel side with respect to the grip portion; and
molding the operation handle member by performing injection molding using the mold.
